(19) United States
(12) Patent Application Publication
(10) Pub. No.: US 2005/0085131 A1
(43) Pub. Date: Apr. 21, 2005

(54) Wall-mounted electrical appliance base adapter to light bulb socket

(76) Inventor: Dennis G. Sutherland, Chula Vista, CA (US)

Correspondence Address: CHARMASSON & BUCHACA & LEACH LLP, 1545 HOTEL CIRCLE SOUTH, SUITE 150, SAN DIEGO, CA, 92108-3412, US

(21) Appl. No.: 10/688,215

(22) Filed: Oct. 15, 2003

(51) Int. Cl. H01R 25/00

(52) U.S. Cl. 439/642

(57) ABSTRACT

An adapter for releasably mounting a wall-mountable household electrical appliance, such as a motion sensor security light fixture to a quick-release household electrical socket such as a screw-in type light bulb socket. The adapter has a first end shaped to form a typical junction box fitting for mounting to most typical wall-mountable applicance bases. The other end of the adapter is formed into an engagement for the socket. Electrical connection between the adapter and appliance is more rapidly accomplished by a universal electrical connector which provides a number of standard electrical connection terminator types. Angular orientation of the appliance is accomplished in-situ and the appliance is secured to the adapter using a clip structure. A method for obtaining proper upright orientation for screw-type Edison sockets using the inventive adapter is also provided.

### FIELD OF THE INVENTION

This invention relates to household electrical appliances and more particularly to wall-mountable appliances such as motion detector light assemblies.

### BACKGROUND OF THE INVENTION

Electrical appliances such as security lights combining light bulbs and motion detectors have long been available for mounting to a wall, typically at an open-faced electrical junction box. The location of the appliance is often restricted by the location of an existing junction box. The installation of a new junction box requires additional time, expense and often a specialized skill beyond that of many people. Also, once placed, the fixture is semipermanent requiring an extensive amount of time, effort and skill to move the appliance to a new location which, again, would particularly be semi-permanent.

Light socket mountable portable security type appliances have been proposed, such as that disclosed in Stachurski, U.S. Pat. No. 6,049,274. The main drawback of this device is that the direction of the motion sensor is not adjustable as it typically is in wall mounted units.

The invention results from an attempt to resolve the above-identified problems.

### SUMMARY OF THE INVENTION

The principal and secondary objects of this invention are to provide greater portability and ease of installation to typical wall-mountable electrical appliances such as motion detector light assemblies. It is a further object of the invention to provide adaptability between electrical connectors and wire terminators of various types provided by existing wall-mountable electrical appliances. It is a further object of the invention to provide for in-situ adjustable orientation of the appliance.

These and other objects are achieved by an adapter having a first end shaped and sized to form a typical junction box fitting for mounting to most typical household wall-mountable electrical applicance bases. The other end of the adapter is formed to mount to a common electrical socket such as an Edison-type screw-in light bulb socket. Electrical connection between the adapter and appliance is more rapidly accomplished by use of a universal electrical connector associated with the adapter which provides a number of standard electrical connection terminator types. Angular orientation of the appliance is accomplished in-situ and the appliance is secured to the adapter using a clip structure. A method for obtaining proper upright orientation for screw-type Edison sockets using the inventive adapter is also provided.

### BRIEF DESCRIPTION OF THE DRAWING

FIG. 1 is a diagrammatic exploded perspective view of a motion sensor light appliance and an adapter according to the invention;

FIG. 2 is a partial cross-sectional diagrammatic perspective view of an electrical connector according to the invention;

FIG. 3 is a diagrammatic perspective view of an alternate household electrical socket engagement for the adapter according to the invention;

FIG. 4 is a diagrammatic cross-sectional view of an alternate embodiment of the adapter having an alternate clip-shape for unflanged appliance bases;

FIG. 5 is a diagrammatic perspective view of an alternate adapter providing a number of acceptable angular orientation mounts; and

FIG. 6 is a flow chart diagram of a method according to the invention for orienting an appliance to an adapter.

### DESCRIPTION OF THE PREFERRED EMBODIMENT OF THE INVENTION

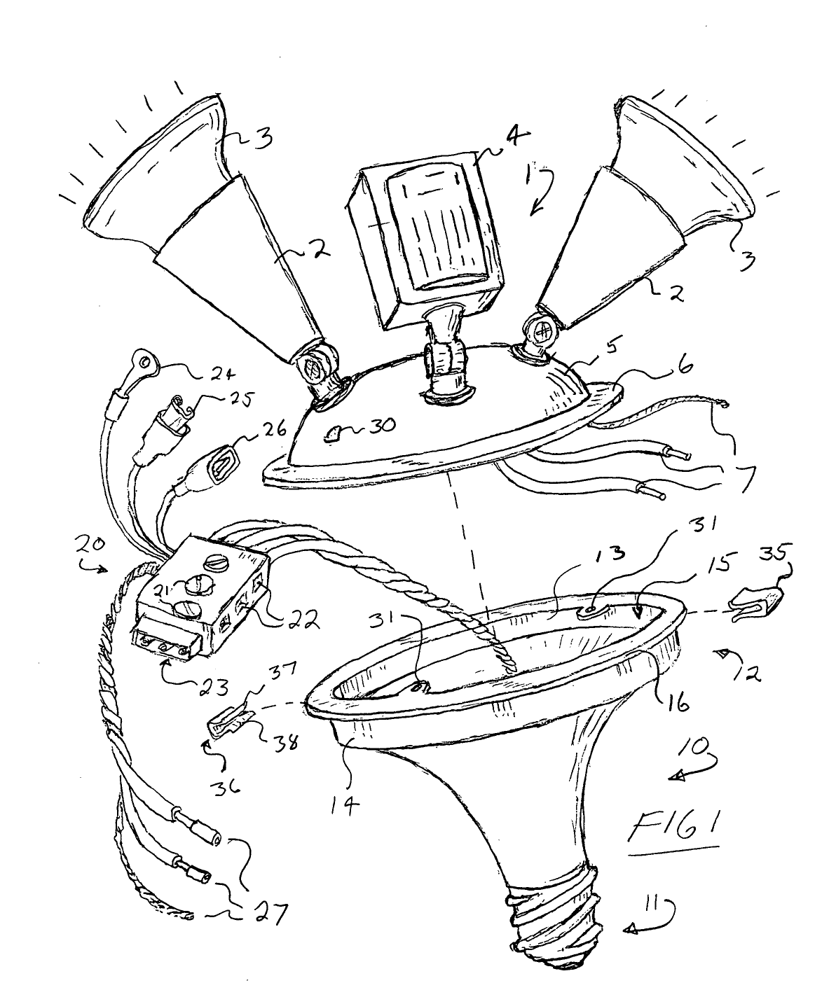

Referring now to the drawing, there is shown in FIG. 1, a typical wall-mountable electrical appliance 1 in the form of a motion detector light assembly having dual movable light fixtures 2 for carrying light bulbs 3 and a movable motion detector unit 4 mounted to a base 5 having a lower peripheral flange 6 and electrical connection wires 7. An adapter 10 is provided having a first end 11 formed into an electrical socket engagement for a screw, Edison-type light bulb socket. The opposite end 12 of the adapter is formed into an electrical junction box shaped and sized portion 13 having a generally cylindrical housing 14 having an open top 15. A flange 16 extends outwardly from an upper peripheral edge of the housing and has an outer diameter substantially commensurate with the outer diameter of the base flange 6. Hot, neutral and ground wiring connections are made through use of a universal electrical connector 20 having a plurality of electrical connection terminator types, including screw-types 21, push-in wire-type insertion capture ports 22, standardized jack-types 23, a variety of single-wire terminator-types such as looped end 24 and friction plug 25, 26 connectors and bare end wire-types 27 available for twist-cap type connection.

Mounting of the appliance to the adapter can be made through screw fasteners, through holes 30 in the base aligned with threaded receptacle tabs 31 inwardly projecting from the peripheral wall of the junction box portion of the adapter.

More preferably, an angularly adjustable mounting is provided so that the in-situ angular orientation of the base 5 with respect to the adapter 10 is possible. Adjustable mounting of the base to the adapter is made through clips 35, 36 attachable along the interfaced flanges of the base and junction box portions. In this way, a clip 36 provides a top prong 37 for bearing against an upwardly facing surface of the base 5, and a bottom prong 38 for bearing against a downwardly facing surface of the adapter.

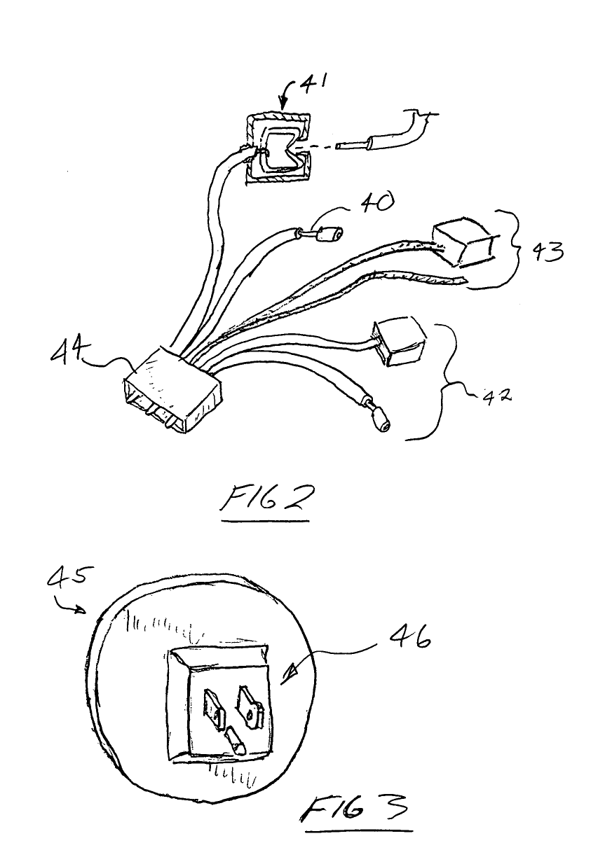

The expense of providing a universal adapter can be avoided by simply providing the two most common terminator types such as bare wire end 40 for twisting cap connections, and a push-in wire connection terminator 41 such as the IN-SURE brand push-in wire terminators available from Ideal Industries, Inc. of Sycamore, Ill. In its simplest approach, both bare wire end and the push-in type terminators are wired in parallel to the engagement contacts and provided for the hot 40, 41, neutral 42, and ground 43 connections. Alternately, as shown in FIG. 2, these terminators can be provided connected to a simple male-type jack 44 for mating to a corresponding female jack which is wired to the engagement of the adapter.

Those skilled in the art will readily appreciate that the invention can be readily adapted to provide an adapter 45 having an engagement 46 which connects to other common quick-release electrical sockets such as bayonet-type lamp sockets and wall-outlet sockets as shown in FIG. 3.

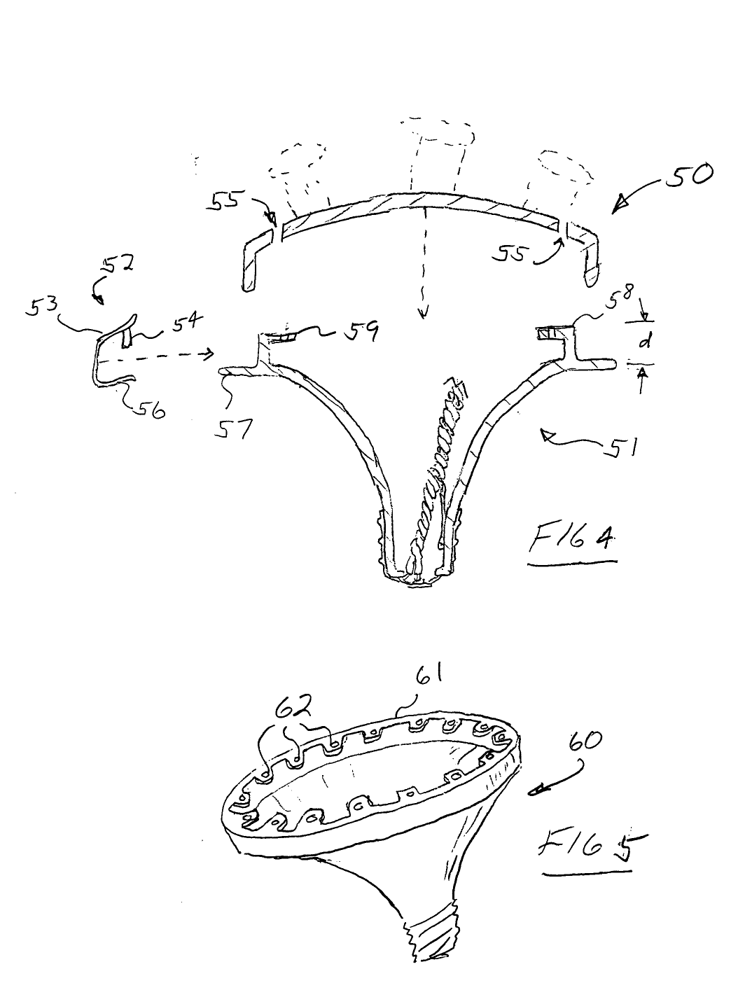

Referring now to FIG. 4, many existing applicance base portion designs do not provide a flange but rather have a generally convex-shaped base 50. Such bases can still be mounted to the adapter 51 in an angularly adjustable fashion. An alternate embodiment of a clip 52 is provided having an angled upper prong 53 having a downwardly projecting pin 54 sized to penetrate through existing fastener holes 55 through the appliance base. The clip has a bottom prong 56 for contacting the circumferential flange 57 projecting from the junction box portion along a lower edge a distance d from the peripheral top edge 58. Care should be taken to limit the length of the pin 54 so that it does not interfere with fastener tabs 59, if an, on the adapter.

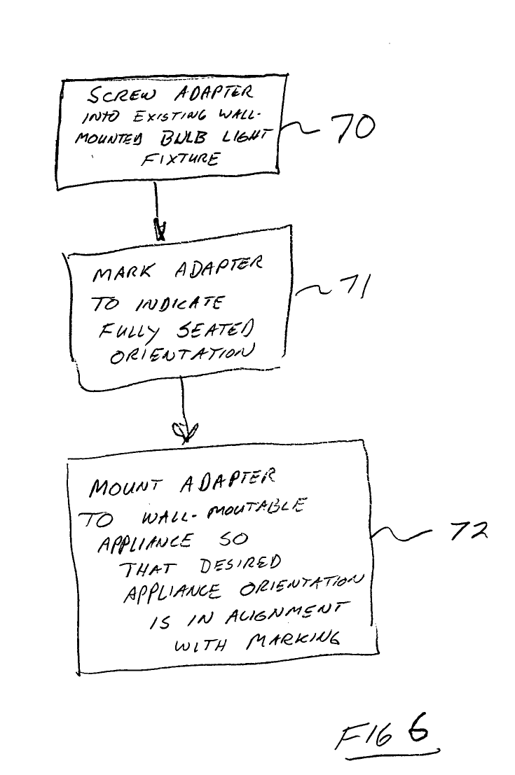

Referring now to FIG. 5, there is shown an alternate embodiment of the adapter 60 having a junction box end portion 61 having a plurality of inwardly projecting threaded fastener tabs 62 angularly spaced-apart along the upper peripheral edge of the junction box portion. This allows mounting of the base portion of the applicance to a number of angular positions.

Many existing wall-mountable appliances are provided with various means for selecting an angular orientation between the appliance and existing junction boxes. This is provided due to the fact that most junction boxes are already positioned and may not provide tabs in a desired orientation. For such appliances, the mounting of the adapter according to the invention to the appliance may be made in such a way as to properly align the adapter to the appliance. One can readily appreciate the problem in that if the adapter is mounted haphazardly to appliance and then the appliance and adapter assembly is, for example, screwed into an existing wall-mounted light socket, the assembly may become properly seated where the orientation of the appliance is not desired.

In order to overcome this problem, there is the following method. Referring now to FIG. 6, the screw-type adapter is first screwed into an existing wall-mounted bulb light fixture 70. Once fully seated, the relative orientation of the adapter to the wall is noted and the adapter marked 71 accordingly, such as through a piece of tape applied to the topmost surface of the adapter. Since many screw-type threading designs use multi-helical threads, the user should also note the orientation of the adapter when the threads immediately disengage. The adapter is then mounted to the wall-mountable appliance so that the marking is aligned with the topmost portion of the appliance when the appliance is held in its desired, eventual orientation 72.

While the preferred embodiments of the invention have been described, modifications can be made and other embodiments may be devised without departing from the spirit of the invention and the scope of the appended claims.

1. An adapter for mounting a wall-mountable household electrical appliance having a base portion for semi-permanently mounting to an electrical junction box, to a quick-release household electrical socket, said adapter comprises:
a first end portion sized and shaped to be commensurate with said junction box; and
a second end formed into a quick-release household electrical socket engagement.

2. In a wall-mountable household electrical appliance having a base portion for semi-permanently mounting to an electrical junction box, an improvement which comprises:
an adapter which comprises:
a first end portion sized and shaped to be commensurate with said junction box; and
a second end formed into a quick-release, household electrical socket engagement.

3. The improvement of claim 2, wherein said engagement is of a type selected from the group consisting of:
threaded types, bayonet types, and wall socket plug-in types.

4. The improvement of claim 2, which further comprises:
a universal electrical connector wired to said engagement and having a plurality of electrical terminators each of a different type.

5. The improvement of claim 4, wherein each of said terminators are parallelly connected to one another.

6. The improvement of claim 4, wherein a first of said terminators is a wire having a stripped end portion, and a second of said terminators is a push-in type terminator.

7. The improvement of claim 4, wherein said universal electrical connector is wired to said engagement through a mated pair of jacks.

8. The improvement of claim 2, wherein said first end comprises:
an open-topped housing having a side wall; and
a flange extending outwardly from an outer surface of said side wall.

9. The improvement of claim 8, wherein said improvement further comprises a clip for releasably holding together said appliance and said adapter, said clip being sized and shaped to provide a first prong for bearing against an upwardly facing surface of said base portion, and a second prong for bearing against a downwardly facing surface of said flange.

10. A method for obtaining upright orientation of a wall-mountable household appliance when mounted to an adapter having a screw-in type socket engagement, said method comprises:
fully seating said adapter into a desired socket to achieve a seated-in orientation of said adapter;
marking said adapter to record said orientation;
mounting said appliance to said adapter in a relative angular position so that said appliance is in a desired orientation when said adapter is reseated in said socket.
